(19) United States
(12) Patent Application Publication
(10) Pub. No.: US 2017/0153045 A1
(43) Pub. Date: Jun. 1, 2017

(54) SOLAR ABSORPTION STRUCTURE

(71) Applicant: Metal Industries Research & Development Centre, Kaohsiung (TW)

(72) Inventors: Yu-Lin Chung, Kaohsiung City (TW); Kuang-Kuo Wang, Kaohsiung City (TW); Chia-Hung Huang, Kaohsiung City (TW); Ho-Chung Fu, Kaohsiung City (TW)

(21) Appl. No.: 14/953,027

(22) Filed: Nov. 27, 2015

(51) Int. Cl. F24J 2/48; G02B 5/28; G02B 1/11

(52) U.S. Cl. CPC F24J 2/487; G02B 1/11; G02B 5/28

(57) ABSTRACT

A solar absorption structure including a base, a reflective layer, a light interference layer and an absorption layer is provided. The reflective layer is disposed on the base, wherein a material of the reflective layer includes metallic glass. The light interference layer is disposed on the reflective layer, and the reflective layer is located between the base and the light interference layer. The absorption layer is disposed on the light interference layer, wherein the light interference layer is located between the reflective layer and the absorption layer, and a material of the absorption layer includes metallic glass.

### BACKGROUND

Field of the Invention

The invention is directed to a solar absorption structure and more particularly, to a solar selective absorption structure.

Description of Related Art

As the International energy prices rise gradually, countries are dedicated to the researches and applications of solar energy to obtain low-price and environmental pollution-free energy. The applications of solar energy can be classified into solar cells and solar thermoelectricity.

As for solar cells, a solar cell is capable of directly converting sunlight as received into electricity and thus, is applicable to a sunny region. However, most solar cells can convert only 10% to 20% of the sunlight into electricity, while most of the other part of the sunlight cannot be utilized and thus, converted into thermal energy or radiated back to the air. As for the solar thermoelectricity, a solar absorption structure converts the sunlight received thereby into the thermal energy to heat a working fluid and generate kinetic energy, so as to drive a power generator to generate electricity. The power generation efficiency of the solar thermoelectricity approximately reaches up to 30% and is slightly higher than the solar cells. How to advance absorption efficiency of the solar absorption structure has currently become an important topic in the solar energy field.

### SUMMARY

The invention provides a solar absorption structure with good solar absorption efficiency.

The solar absorption structure of the invention includes a base, a reflective layer, a light interference layer and an absorption layer. The reflective layer is disposed on the base, wherein a material of the reflective layer includes metallic glass. The light interference layer is disposed on the reflective layer, wherein the reflective layer is located between the base and the light interference layer. The absorption layer is disposed on the light interference layer, wherein the light interference layer is located between the reflective layer and the absorption layer, and a material of the absorption layer includes metallic glass.

In an embodiment of the invention, a thickness of the absorption layer is less than a thickness of the reflective layer.

In an embodiment of the invention, a thickness of the reflective layer ranges between 100 nm and 300 nm.

In an embodiment of the invention, the thickness of the absorption layer ranges between 1 nm and 20 nm.

In an embodiment of the invention, a light with a wavelength section is adapted to at least partially pass through the absorption layer and the light interference layer in sequence to transmit toward the reflective layer, and at least part of the light is adapted to be reflected between the reflective layer and the absorption layer by interference of the interference layer, and to be absorbed by the absorption layer.

In an embodiment of the invention, the wavelength section ranges between a first wavelength and a second wavelength, and a thickness of the light interference layer ranges between ¼ of the first wavelength and ¼ of the second wavelength.

In an embodiment of the invention, the wavelength section is a wavelength section of visible light or a wavelength section of visible light and near-infrared light.

In an embodiment of the invention, the thickness of the light interference layer ranges between 200 nm and 1000 nm.

In an embodiment of the invention, a material of the reflective layer includes at least one of copper (Cu), silver (Ag), chromium (Cr), titanium (Ti), aluminum (Al), zirconium (Zr), yttrium (Y) and nickel (Ni).

In an embodiment of the invention, a material of the absorption layer includes at least one of copper (Cu), silver (Ag), chromium (Cr), titanium (Ti), aluminum (Al), zirconium (Zr), yttrium (Y) and nickel (Ni).

In an embodiment of the invention, a material of the light interference layer comprises at least one of Al₂O₃, SiO₂, SiO, TiO₂ and ZrO₂.

In an embodiment of the invention, the solar absorption structure includes an anti-reflective layer. The anti-reflective layer is disposed on the absorption layer, and the absorption layer is located between the light interference layer and the anti-reflective layer.

In an embodiment of the invention, a thickness of the anti-reflective layer ranges between 20 nm and 300 nm.

In an embodiment of the invention, a material of the anti-reflective layer includes at least one of Al₂O₃, SiO₂, SiO, TiO₂ and ZrO₂.

To sum up, in the solar absorption structure of the invention, the light interference layer is disposed between the reflective layer and the absorption layer. Thereby, the sunlight after sequentially passing through the absorption layer and the light interference layer to transmit toward the reflective layer can be interfered by the light interference layer to be repeatedly reflected between the reflective layer and the absorption layer, such that the efficiency of the sunlight being absorbed by the absorption layer can be increased. Moreover, both the reflective layer and the absorption layer are made of the materials including the metallic glass and thus, have higher solar absorption efficiency. Since the metallic glass has better rigidness and oxidation resistance than the metallic material used in the conventional solar absorption structure, the solar absorption structure of the invention can have better weatherability. In addition, the metallic glass has high reflectivity in wavelength sections of ultraviolet (UV) light and far infrared (IR) light and thus, can slow down the velocity of the solar absorption structure radiating its heat to the outside. Moreover, the metallic glass has a small film thickness and thus, can contribute to not only increasing production rate and lowering down production cost, but also reducing overall thickness of films, such as the reflective layer, the light interference layer and the absorption layer, to prevent the layers from peeling off due to internal stress.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a solar absorption structure according to an embodiment of the invention.

FIG. 2 illustrates the sunlight irradiating to the solar absorption structure depicted in FIG. 1.

FIG. 3 illustrates the solar absorption structure depicted in FIG. 1 being applied in heating a working fluid.

### DESCRIPTION OF EMBODIMENTS

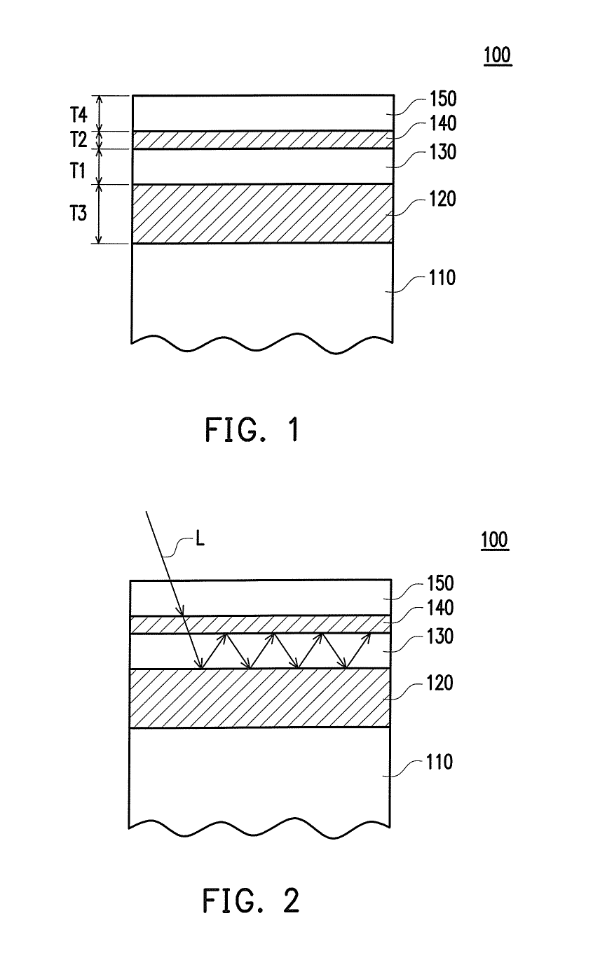

FIG. 1 is a schematic diagram illustrating a solar absorption structure according to an embodiment of the invention. Referring to FIG. 1, a solar absorption structure 100 of the present embodiment includes a base 110, a reflective layer 120, a light interference layer 130, an absorption layer 140 and an anti-reflective layer 150. The reflective layer 120 is disposed on the base 110. The light interference layer 130 is disposed on the reflective layer 120, such that the reflective layer 120 is located between the base 110 and the light interference layer 130. The absorption layer 140 is disposed on the light interference layer 130, such that the light interference layer 130 is located between the reflective layer 120 and the absorption layer 140. The anti-reflective layer 150 is disposed on the absorption layer 140, such that the absorption layer 140 is located between the light interference layer 130 and the anti-reflective layer 150.

FIG. 2 illustrates the sunlight irradiating to the solar absorption structure depicted in FIG. 1. The sunlight L from the outside may enter the solar absorption structure 100 through the anti-reflective layer 150 to reach the absorption layer 140 as illustrated in FIG. 2, and at least part of the sunlight L is absorbed by the absorption layer 140 and converted into thermal energy. Part of the sunlight L passing through the absorption layer 140 reaches the reflective layer 120 and is reflected to the absorption layer 140 by the reflective layer 120 to be absorbed by the absorption layer 140 and converted into the thermal energy. Furthermore, the light interference layer 130 is disposed between the reflective layer 120 and the absorption layer 140 of the solar absorption structure 100 in the present embodiment, and thus, the sunlight L after sequentially passing through the absorption layer 140 and the light interference layer 130 to transmit toward the reflective layer 120 may be repeatedly reflected between the reflective layer 120 and the absorption layer 140 by the interference effect of the light interference layer 130, so as to increase the efficiency of the sunlight L being absorbed by the absorption layer 140. It should be mentioned that when the sunlight L is repeatedly reflected between reflective layer 120 and the absorption layer 140, a small part of the sunlight L may also be transmitted toward outside through the absorption layer 140, but the invention is not intent to limit the transmission of the light inside the solar absorption structure 100.

The solar absorption structure 100 of the present embodiment is adapted to absorb the light of a specific wavelength section in the sunlight L. The wavelength section is between a first wavelength and a second wavelength, and a thickness T1 (illustrated in FIG. 1) of the light interference layer 130 ranges between ¼ of the first wavelength and ¼ of the second wavelength to achieve the light interference effect. To be specific, the wavelength section may be approximately a wavelength section of visible light or a wavelength section of a visible light and a near-infrared light. The first wavelength and the second wavelength may be 250 nm and 750 nm, respectively, and the thickness T1 of the light interference layer 130 is correspondingly designed to range between 112.5 nm and 187.5 nm. However, the invention is not limited thereto, and the thickness T1 of the light interference layer 130 may be designed to range between 200 nm and 1000 nm or other appropriate thickness based on requirements.

In the present embodiment, the reflective layer 120 is made of metallic glass (which is also referred to as an amorphous metal), and the metallic glass is, for example, aluminum-based metallic glass or copper-based metallic glass, which may include at least one metallic material of copper (Cu), silver (Ag), chromium (Cr), titanium (Ti), aluminum (Al), zirconium (Zr), yttrium (Y) and nickel (Ni). The light interference layer 130 is made of a material including at least one of Al₂O₃, SiO₂, SiO, TiO₂ and ZrO₂, for example, and the light interference layer 130 may be doped with a metallic material or not doped with the metallic material. The metallic material doped in the light interference layer 130 may be the same as or different from the metallic material contained in the reflective layer 120, and ratio of the metallic material doped in the light interference layer 130 may be less than 10%. The absorption layer 140 is made of metallic glass, and the metallic glass is, for example, aluminum-based metallic glass or copper-based metallic glass, which may include at least one metallic material of copper (Cu), silver (Ag), chromium (Cr), titanium (Ti), aluminum (Al), zirconium (Zr), yttrium (Y) and nickel (Ni). The anti-reflective layer 150 is made of a material including at least one of Al₂O₃, SiO₂, SiO, TiO₂ and ZrO₂, for example.

Both the reflective layer 120 and the absorption layer 140 are made of a material including the metallic glass and thus, have higher solar absorption efficiency. Since the metallic glass has better rigidness and oxidation resistance than the metallic material used in the conventional solar absorption structure, the solar absorption structure 100 of the present embodiment has better weatherability. In addition, the metallic glass has high reflectivity in wavelength sections of ultraviolet (UV) light and far infrared (IR) light and thus, can slow down the velocity of the solar absorption structure 100 radiating its heat to the outside. Moreover, the metallic glass has a small film thickness and thus, can contribute to not only increasing production rate and lowering down production cost, but also reducing overall thickness of the film structures consisting of the reflective layer 120, the light interference layer 130, the absorption layer 140 and the anti-reflective layer 150 to prevent the layer structures from peeling off due to internal stress.

The film structure is manufactured by, for example, an in-line physical vapor deposition (PVD) process, which has a high production efficiency, is an environmental pollution-free process and meets with demands for environment protection and mass production.

In the present embodiment, a thickness T2 (illustrated in FIG. 1) of the absorption layer 140 ranges, for example, between 1 nm and 20 nm, and a thickness T3 (illustrated in FIG. 1) of the reflective layer 120 ranges, for example, between 100 nm and 300 nm. Namely, the thickness of the absorption layer 140 is less than the thickness of the reflective layer 120, such that the absorption layer 140 has better light transmittance, and the reflective layer 120 has better reflectivity. In other embodiments, the absorption layer 140 and the reflective layer 120 may have other appropriate thicknesses, which are not limited in the invention. Additionally, a thickness T4 (illustrated in FIG. 1) of the anti-reflective layer 150 of the present embodiment ranges, for example, between 20 nm and 300 nm, but the invention is not limited thereto.

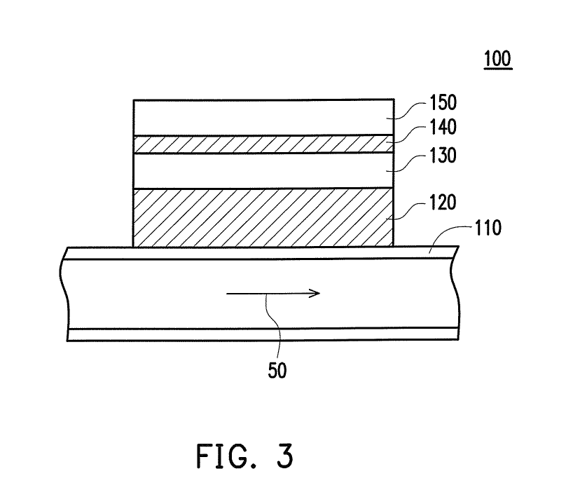

FIG. 3 illustrates the solar absorption structure depicted in FIG. 1 being applied in heating a working fluid. The base 110 of the solar absorption structure 100 illustrated in FIG. 1 may be a pipeline as illustrated in FIG. 3, such that a working fluid 50 inside the pipeline is heated by the heat absorbed by the solar absorption structure 100, so as to generate a kinetic energy to drive a power generator to generate electricity. In other embodiments, the heat absorbed by the solar absorption structure 100 may also be applied to other apparatuses, which is not limited in the invention.

In light of the foregoing, in the solar absorption structure of the invention, the light interference layer is disposed between the reflective layer and the absorption layer. Thereby, the sunlight after sequentially passing through the absorption layer and the light interference layer to transmit toward the reflective layer can be interfered by the light interference layer to be repeatedly reflected between the reflective layer and the absorption layer, such that the efficiency of the sunlight being absorbed by the absorption layer can be increased. Moreover, both the reflective layer and the absorption layer are made of the materials including the metallic glass and thus, have higher solar absorption efficiency. Since the metallic glass has better rigidness and oxidation resistance than the metallic material used in the conventional solar absorption structure, the solar absorption structure of the invention can have better weatherability. In addition, the metallic glass has high reflectivity in wavelength sections of ultraviolet (UV) light and far infrared (IR) light and thus, can slow down the velocity of the solar absorption structure radiating its heat to the outside. Moreover, the metallic glass has a small film thickness and thus, can contribute to not only increasing production rate and lowering down production cost, but also reducing overall thickness of films, such as the reflective layer, the light interference layer and the absorption layer, to prevent the layers from peeling off due to internal stress.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A solar absorption structure, comprising:
a base;
a reflective layer, disposed on the base, wherein a material of the reflective layer comprises metallic glass;
a light interference layer, disposed on the reflective layer, wherein the reflective layer is located between the base and the light interference layer; and
an absorption layer, disposed on the light interference layer, wherein the light interference layer is located between the reflective layer and the absorption layer, and a material of the absorption layer comprises metallic glass.

2. The solar absorption structure according to claim 1, wherein a thickness of the absorption layer is less than a thickness of the reflective layer.

3. The solar absorption structure according to claim 1, wherein a thickness of the reflective layer ranges between 100 nm and 300 nm.

4. The solar absorption structure according to claim 1, wherein a thickness of the absorption layer ranges between 1 nm and 20 nm.

5. The solar absorption structure according to claim 1, wherein a light of a wavelength section is adapted to at least partially pass through the absorption layer and the light interference layer in sequence to transmit toward the reflective layer, and at least part of the light is adapted to be reflected between the reflective layer and the absorption layer by interference of the interference layer, and to be absorbed by the absorption layer.

6. The solar absorption structure according to claim 5, wherein the wavelength section ranges between a first wavelength and a second wavelength, and a thickness of the light interference layer ranges between ¼ of the first wavelength and ¼ of the second wavelength.

7. The solar absorption structure according to claim 5, wherein the wavelength section is a wavelength section of visible light or a wavelength section of visible light and near-infrared light.

8. The solar absorption structure according to claim 1, where a thickness of the light interference layer ranges between 200 nm and 1000 nm.

9. The solar absorption structure according to claim 1, wherein a material of the reflective layer comprises at least one of copper (Cu), silver (Ag), chromium (Cr), titanium (Ti), aluminum (Al), zirconium (Zr), yttrium (Y) and nickel (Ni).

10. The solar absorption structure according to claim 1, wherein a material of the absorption layer comprises at least one of copper (Cu), silver (Ag), chromium (Cr), titanium (Ti), aluminum (Al), zirconium (Zr), yttrium (Y) and nickel (Ni).

11. The solar absorption structure according to claim 1, wherein a material of the light interference layer comprises at least one of Al₂O₃, SiO₂, SiO, TiO₂ and ZrO₂.

12. The solar absorption structure according to claim 1, comprising:
an anti-reflective layer, disposed on the absorption layer, wherein the absorption layer is located between the light interference layer and the anti-reflective layer.

13. The solar absorption structure according to claim 12, wherein a thickness of the anti-reflective layer ranges between 20 nm and 300 nm.

14. The solar absorption structure according to claim 12, wherein a material of the anti-reflective layer comprises at least one of Al₂O₃, SiO₂, SiO, TiO₂ and ZrO₂.
